(19) United States
(12) Patent Application Publication
(10) Pub. No.: US 2025/0026910 A1
(43) Pub. Date: Jan. 23, 2025

(54) COMPOSITION

(71) Applicant: INOVYN EUROPE LIMITED, Runcorn Cheshire (GB)

(72) Inventor: Thomas HERMANT, Lonzee (BE)

(21) Appl. No.: 18/708,946

(22) PCT Filed: Nov. 8, 2022
(86) PCT No.: PCT/EP2022/081096

§ 371 Date: May 9, 2024

(30) Foreign Application Priority Data
Nov. 11, 2021 (EP) 21207833.1

(51) Int. Cl. C08K 3/26; C08F 214/06

(52) U.S. Cl. CPC C08K 3/26; C08F 214/06; C08F 2800/20; C08K 2003/267

(57) ABSTRACT

A composition that includes a polyvinylchloride containing copolymer which comprises vinyl chloride and a second monomer, and wherein the second monomer is a monomer whose homopolymer has a glass transition temperature, Tg, of less than 82° C., and up to 10 wt % of a hydrotalcite compound, wherein the hydrotalcite compound has 20.5 wt % or less of magnesium.

### BACKGROUND OF THE INVENTION

The present invention relates to a composition, and in particular a composition comprising a vinyl chloride containing copolymer and having good powder flow properties even after storage.

Polyvinylchloride (PVC) is one of the most important thermoplastic materials on the market today. Given its very good mechanical and physical properties, it is used in a large number of applications.

Several processes are known for the preparation of PVC. For example, PVC may be prepared by suspension polymerisation of vinyl chloride in a suspending liquid and in the presence of a suspending agent. This produces a slurry (or suspension) of PVC particles, typically of the order of 100 to 200 microns particle size. The resulting slurry of PVC is then dried, usually by centrifuging followed by fluid bed drying, to give a porous (i.e. sorbent) PVC. PVC produced by the suspension method is referred to as “S-PVC”. S-PVC can absorb plasticisers to give a dry blend.

PVC can also be produced by what are generally known as paste or emulsion polymerisation processes. Emulsion polymerisation processes may be characterised in that the polymerisation produces a latex of polymer particles of relatively small size compared to the S-PVC process, typically 0.1 to 5 microns. The latex can be dried, for example by spray-drying to produce PVC particles in the form of agglomerates. The dried PVC polymer particles are typically much smaller than the dried particles produced by the suspension PVC processes.

It is known to add additives to PVC to make it suitable for different applications. It is also known to polymerise the vinyl chloride monomer in the presence of a comonomer which gives improved properties. The most common comonomer for PVC is vinyl acetate.

The PVC polymer is often produced and stored in the form of a dry powder. It may be stored and, if needed, shipped in a “loose” form, for example stored in a silo and shipped in a tanker truck. The PVC may also be stored (and optionally shipped) in bags. During storage the powder may agglomerate, leading to a material which may have lumps or even be completely compacted. To prevent this additives may be added to the powder. Such additives are commonly known as “anticaking agents” or “flowability improvers”. Compounds known in the art as anticaking agents for PVC powder include calcium carbonate and silica. (It should be note that “flowability” in this sense refers to powder flowability, not a property such as “melt flow” which is a measure of flowability or fluidity of melted PVC.)

PVC homopolymer itself is generally fairly rigid. It is known to add plasticisers to PVC to make it more flexible. These substances may be liquids with low volatility or solids. However, in general the flexibility of such products is not long lasting. An alternative method to improve the flexibility of PVC is to “pre-plasticise” it by polymerising vinyl chloride monomer in the presence of a comonomer which gives improved flexibility. Particularly preferred comonomers are acrylates and methacrylates. WO 2015/090657, for example, describes a process for the preparation of a polymer by reacting vinyl halide and a second monomer, preferably an acrylate, and in which the polymerisation is prepared in a series of steps in which the amounts of each monomer are controlled. This document notes that with the correct ratio of monomers in the final product there is no need to add additional plasticiser.

### SUMMARY OF THE INVENTION

We have now found that specific classes of hydrotalcite are useful as anticaking agents. In particular, hydrotalcites are known to be added to PVC to act as thermal stabilisers and/or fillers. However, we have found that specific classes of hydrotalcite can provide very effective anticaking agents even over significant periods of time. This is particularly surprising because “conventional” anticaking agents and also other hydrotalcite compounds have been found to be ineffective for this purpose.

### BRIEF DESCRIPTION OF DRAWINGS

FIG. 1 is a photograph showing flowability test results of a comparative composition sample in which no anticaking agent was added.

FIG. 2 is a photograph showing flowability test results of a comparative composition sample that contains a known anti-caking agent.

FIG. 3 is a photograph showing flowability test results of a comparative composition sample that contains hydrotalcite with a Mg content of 22.8 wt %.

FIGS. 4A and 4B are photographs showing flowability test results of a comparative composition sample that contains hydrotalcite with a Mg content of 20.8 wt %.

FIGS. 5A and 5B are photographs showing flowability test results of a comparative composition sample that contains hydrotalcite with a Mg content of 22.3 wt %.

FIG. 6 is a photograph showing flowability test results of a comparative composition sample that contains hydrotalcite with a Mg content of 20.0 wt %.

FIG. 7 is a photograph showing flowability test results of a comparative composition sample that contains hydrotalcite with a Mg content of 15.1 wt %.

FIG. 8 is a photograph showing flowability test results of a comparative composition sample that contains hydrotalcite with a Mg content of 19.9 wt %.

FIG. 9 is a photograph showing flowability test results of a comparative composition sample that contains hydrotalcite with a Mg content of 14.3 wt %.

### DETAILED DESCRIPTION OF THE INVENTION

Thus, in a first aspect the present invention provides a composition which comprises:
a. A polyvinylchloride containing copolymer which comprises vinyl chloride and a second monomer, and wherein the second monomer is a monomer whose homopolymer has a glass transition temperature, Tg, of less than 82° C., and
b. Up to 10 wt % of a hydrotalcite compound,
wherein the hydrotalcite compound has 20.5 wt % or less of magnesium.

As a first component the composition comprises a polyvinylchloride containing copolymer. The copolymer comprises vinyl chloride and a second monomer. The second monomer is a monomer whose homopolymer has a glass transition temperature, Tg, of less than 82° C. Such monomers are known in the art, and in fact are commonly called “soft monomers”. Examples, and monomers which are therefore particularly preferred for the second monomer in the copolymer component of the present invention, include vinyl carboxylates, vinyl ethers, olefins and alkyl (meth)acrylates. Particularly preferred second monomers are vinyl carboxylates, particularly vinyl acetate, and alkyl (meth)acrylates.

In preferred embodiments the second monomer is a monomer whose homopolymer has a glass transition temperature, Tg, of less than 70° C., such as less than 50° C. Preferred second monomers may be monomers whose homopolymers have a glass transition temperature below 20° C., or even below 0° C. The glass transition temperature of poly (vinyl acetate), for example, is 30° C., whilst poly (alkyl acrylates) having C1 to C10 alkyl groups generally have glass transition temperatures below 0° C. The glass transition temperature for poly (butyl acrylate), for example, is −53° C.

The glass transition temperature of a polymer is a well-known parameter which can be found in textbooks and data tables or can be measured experimentally. In the present invention, the glass transition temperature, Tg, is the value obtained by Dynamic Mechanical Analysis under the conditions set out in ASTM E1640-18 “Standard Test Method for Assignment of the Glass Transition Temperature by Dynamic Mechanical Analysis”.

The copolymer may be produced by any suitable polymerisation process in which vinyl chloride monomer and the second monomer are copolymerised, including suspension and emulsion polymerisation processes. Such processes are well-known in the art.

The copolymer may typically comprise at least 40 wt % vinyl chloride and up to 60 wt % of the second monomer. However, it is preferred that the copolymer comprises at least 50 wt % vinyl chloride, such as at least 60 wt % vinyl chloride.

Other monomers may also be present in addition to the vinyl chloride and second monomer. In particular, and for the avoidance of doubt, as used herein the term “copolymer” encompasses polymers comprising two or more monomers. This includes polymers having just two monomers i.e. the vinyl chloride and the second monomer, and also polymers comprising three or more monomers i.e. the vinyl chloride, a second monomer and one or more other monomers. (Polymers comprising three monomers may also be referred to as terpolymers for example, and such are included within the definition of copolymers herein.) Any other monomers present (i.e. in addition to vinyl chloride and the second monomer) may also be monomers whose homopolymer has a glass transition temperature, Tg, of less than 82° C., and in some preferred embodiments may also meet the preferred features of the second monomer. They may also, however, in some embodiments be monomers whose homopolymer has a glass transition temperature, Tg, of 82° C. or higher. In all cases where there are two or more monomers other than vinyl chloride (hereinafter two or more “comonomers”), the second monomer is preferably present as at least 50 mol % of the total comonomers present. (In this case, where there are two or more comonomers which both meet the requirements of the second monomer then the one present in the largest amount would then be second monomer according to the claim, for example.)

In a preferred embodiment the second monomer is an alkyl(meth)acrylate. In this embodiment, the copolymer may typically comprise at least 40 wt % vinyl chloride and up to 60 wt % alkyl(meth)acrylate. However, it is preferred that the copolymer comprises at least 50 wt % vinyl chloride, such as at least 60 wt % vinyl chloride. Other comonomers may also be present in addition to the vinyl chloride and alkyl(meth)acrylate, including one or more other second monomers as already defined.

The copolymer most preferably comprises at least 70 wt % vinyl chloride and up to 30 wt % alkyl(meth)acrylate. Particularly preferred polyvinylchloride-alkyl(meth)acrylate copolymers for the first component to the present invention may comprise at least 90 wt % vinyl chloride and up to 10 wt % alkyl(meth)acrylate.

The term “alkyl(meth)acrylate” is used herein as shorthand to refer to alkyl acrylates and alkyl methacrylates. For example butyl(meth)acrylate refers to butyl methacrylate and butyl acrylate.

In preferred embodiments the copolymer is polyvinylchloride-alkyl acrylate copolymer. Nevertheless, where described below it should be considered that the embodiments of the invention, even where reference is made solely to acrylate copolymers, may equally be applied to copolymers formed with other second monomers, including the equivalent methacrylate copolymers, unless the context clearly indicates otherwise.

The alkyl(meth)acrylates preferably comprise a C1 to C10 alkyl group. Preferred alkyl groups comprise C2 to C6 alkyls. Preferred alkyl(meth)acrylates in the copolymer component of the composition of the present invention are alkyl acrylates rather than alkyl methacrylates as already noted. Particularly preferred alkyl(meth)acrylates are ethylhexyl acrylate and n-butyl acrylate, with n-butyl acrylate being most preferred.

As a second component the composition comprises up to 10 wt % of a hydrotalcite compound, wherein the hydrotalcite compound has 20.5 wt % or less of magnesium.

Hydrotalcites are, in general terms, layered double hydroxides comprising magnesium, aluminium, carbonate and hydroxide anions. Unmodified hydrotalcite is a layered double hydroxide (LDH) of general formula Mg6Al2CO3(OH)16·4H2O. This material has a magnesium content of 24.14 wt %. However, hydrotalcites are well known which have a different composition compared to that given by the formula Mg6Al2CO3(OH)16·4H2O. For example, hydrotalcites can be partially substituted with different metals or different anions. Such hydrotalcites are generally considered as “modified hydrotalcites”, where the term “modified hydrotalcite” refers to a hydrotalcite which is a layered double hydroxide comprising magnesium, aluminium, carbonate and hydroxide anions, but which has a formula different from the formula Mg6Al2CO3(OH)16·4H2O.

The hydrotalcite used in the present invention is therefore, in general terms, a modified hydrotalcite, and in more specific terms is a modified hydrotalcite which has a reduced magnesium content of 20.5 wt % or less.

As applied to the hydrotalcite with 20.5 wt % or less magnesium used in the present invention, therefore, the terms “hydrotalcite” and “modified hydrotalcite” are synonymous.

The hydrotalcite of the present invention has a significantly reduced magnesium content compared to unmodified hydrotalcite. The reduced magnesium content in the hydrotalcite of the present invention is typically achieved by removal or replacement of magnesium in the structure, either during synthesis of the structure or by post synthesis treatment. This may be achieved by any suitable method known in the art.

A number of modified hydrotalcite compounds are available commercially. We have found that hydrotalcites which have been modified in a manner which leads to a significant reduction in magnesium content are particularly effective as anticaking agents for polyvinylchloride-alkyl(meth)acrylate copolymers. In contrast, otherwise similar materials with higher magnesium contents are not effective. This is shown in the Examples provided below.

In preferred compositions of the present invention the hydrotalcite compound has 20 wt % or less magnesium. Typically the hydrotalcite compound has at least 10 wt % magnesium. In some embodiments the hydrotalcite may comprise at least 18 wt % of magnesium, such as 18 wt % to 20 wt % magnesium. In other embodiments the hydrotalcite may comprise 18 wt % or less of magnesium, such as 16 wt % or less magnesium, for example 14 wt % to 16 wt % magnesium.

In further preferred compositions the hydrotalcite compound comprises at least one metal selected from Sn, Pb, Ca, Ba, Zn and Cd, and preferably comprises at least 0.2 wt % of at least one metal selected from Sn, Pb, Ca, Ba, Zn and Cd. More preferably the hydrotalcite compound comprises at least 1 wt % of at least one metal selected from Sn, Pb, Ca, Ba, Zn and Cd.

In particularly preferred embodiments the at least one metal is Zn or Ca, and most preferably the at least one metal is Zn.

Where zinc is present, the preferred compositions are those wherein the hydrotalcite compound comprises at least 10 wt % of zinc. Such compounds have shown particularly good effect as anticaking agents even after significant storage of the compositions comprising them.

In other embodiments, which may be combined with the preferred options already recited, it is preferred that the hydrotalcite compound comprises less than 150 ppm (by weight) of sulphur, and preferably less than 100 ppm (by weight) sulphur.

Due to the reduced magnesium content, the hydrotalcite compounds in the composition of the present invention tend to have a lower Mg/Al ratio than unmodified hydrotalcite. In preferred embodiments the hydrotalcite compound has a Mg/Al molar ratio of 2.2 or less, such as 2.0 or less. The Mg/Al ratio may, for example be in the range 1.50 to 2.00, such as 1.50 to 1.90.

The composition of the present invention may be formed in any suitable manner by combining the polyvinylchloride containing copolymer and the hydrotalcite compound. A particularly preferred method introduces the hydrotalcite to the polyvinylchloride containing copolymer after it is produced in the polymerisation reactor but before the copolymer is fully dried. In particular, polyvinylchloride containing copolymers can start to agglomerate during drying, and it is known to add “conventional” anticaking agents before drying to mitigate this. The hydrotalcite compounds of the present invention can then act as an effective anticaking agent both during drying (i.e. in place of more conventional anticaking agents) and provide the longer term anticaking effect which has been found.

In contrast “conventional” anticaking agents have been found to be effective during drying, but not over significantly longer periods e.g. during storage.

Thus, in a second aspect there is provided for use of a hydrotalcite to reduce caking of a composition which comprises a polyvinylchloride containing copolymer which copolymer comprises vinyl chloride and a second monomer, and wherein the second monomer is a monomer whose homopolymer has a glass transition temperature, Tg, of less than 82° C., wherein the hydrotalcite compound has 20.5 wt % or less of magnesium.

The copolymer and the hydrotalcite in this second aspect is preferably as defined for the first aspect.

### EXAMPLES

### Experimental Procedures

### Preparation of Polyvinylchloride Containing Copolymer

In a polymerization reactor with a capacity of 94L and equipped with a stirrer, 54 Kg of water, 3197 gr of a solution of polyvinyl alcohol with a hydrolysis degree of 72.5% at 25.75 gr/Kg in water, 682 gr of a solution of polyvinyl alcohol with a hydrolysis degree of 88% at 30.15 gr/Kg in water, 30 gr of an antifoaming agent, 30 gr of a solution of a buffer (sodium hexametaphosphate-NaHP) at 30 gr/Kg in water, 50 gr of a dispersion in water of a thermal stabilizer (calcium stearate) at 500 gr/Kg and 5 gr of a chain transfer agent (1-dodecanethiol).

Once the reactor was closed and agitation speed set up at 70 rpm, 2 cycles of a vacuum followed by a nitrogen purge were applied, and finally a vacuum was applied. Afterwards 4470 gr of butyl acrylate followed by 5215 gr of vinyl chloride were loaded and the agitation speed is set up at 300 rpm.

The polymerization temperature was raised at 70° C. with the double jacket. An introduction of 9.0 gr of a solution of diethyl peroxydicarbonate in dioctyl adipate with a concentration of 300 gr/Kg is loaded at the temperature of polymerization (70° C.) to start the polymerization. A second introduction of 13 gr of a solution of diethyl peroxydicarbonate in dioctyl adipate with a concentration of 300 gr/Kg at CR>5% and a third introduction of 15 gr of a solution of diethyl peroxydicarbonate in dioctyl adipate with a concentration of 300 gr/Kg is loaded at CR>10%. The reaction was kept under these conditions until the conversion rate of the butyl acrylate reaches a value higher than 80%. Afterwards, 30 gr of a solution of an inhibitor (KI) at 10 gr/Kg in water is added and the polymerization temperature is cooled down to a temperature below 45° C.

Then, 5948 gr of vinyl chloride followed by 434 gr of a solution of polyvinyl alcohol with a hydrolysis degree of 80% at 31.65 gr/Kg in water and finally 30 gr of a solution of diethyl peroxydicarbonate in dioctyl adipate with a concentration of 300 gr/Kg were loaded. The reaction was kept under these conditions until the total conversion rate of vinyl chloride reaches 63.7%. Afterwards 30 gr of a solution of an inhibitor (caustic soda-NaOH) at 220 gr/Kg in water and 30 gr of an antifoaming agent were added to the polymerization medium. The unreacted vinyl chloride was removed by depressurizing the reactor. Then, the suspension was separated by filtration.

A first portion was separated and dried with air at 60° C. in a fluidized bed dryer to provide polyvinylchloride containing copolymer product. The volatile content before drying was about 11 wt %. After drying the volatile content was below 0.3 wt % and the residual butyl acrylate monomer was 12 ppm.

The content of butyl acrylate in the copolymer, determined by 1H NMR, was 38.6 wt %. The bulk density was 0.567 g/cm3 and the average particle size was 236 microns.

Further portions were dried in the same manner except that in each case 4 phr (parts per hundred) of an anticaking agent was added prior to the drying. The details of the anticaking agents are provided below.

In all cases the addition of the anticaking agent resulted, after the drying step, in a free flowing powder sample.

### Compaction Procedure and Flowability Assessment

The samples prepared above were each subjected to the following procedure.

Approximately 20g of the sample is placed in a cylindrical die of diameter 3 cm, and placed in a compressiometer built by Industrial Concept and Assistance, Bierges, Belgium.

The sample is then axially compressed in the die with a force which is increased stepwise from 10 kgforce (98.1 N) to 100 kgforce (981 N).

This compaction is designed to mimic over a short period the long-term compaction that may occur during storage of PVC powder.

At the end of the test the die containing the compressed sample is placed 19 cm above a stainless steel grid with square openings of side 1.8 cm, which is itself in the base of a beaker.

In a first stage, the sample is pushed from the die so that it drops onto the grid. The beaker is then tapped twice gently. A sample is considered to have “excellent” flowability if there is no compaction and it passes completely through the grid at this stage, either before or after the gentle tapping.

If the sample is all or partly compacted such that some powder remains on the grid after the first stage then the beaker is vibrated gently 5-10 times and the sample reassessed. If the sample has then completely flowed through the grid it is considered to have good flowability.

If the sample is still all or partly compared the sample is vibrated further, and in particular more vigorously 15-20 times. If the sample has now completely flowed through the gird it is considered to have flowability, but “poor” flowability. If some, but not all, remains on the grid flowability is deemed as very poor, whilst if all of the original sample remains all or largely as a compacted cylinder then the sample is considered to have no flowability (“none”).

In summary:

TABLE 1

| Flowability | |
|---|---|
| ranking | Criteria |
| Excellent | Sample passes through grid, optionally with gentle tapping |
| | of the beaker |
| Good | Sample passes through grid after 5-10 gentle vibrations |
| Poor | Sample passes through the grid after 15-20 more vigorous |
| | vibrations |
| Very poor | Sample only partly passes through the grid even after the |
| | more vigorous vibrations |
| None | Sample remains completely or largely compacted even |
| | after the more vigorous vibrations |

### Comparative Example 1

In this Comparative Example the sample is that in which no anticaking agent was added.

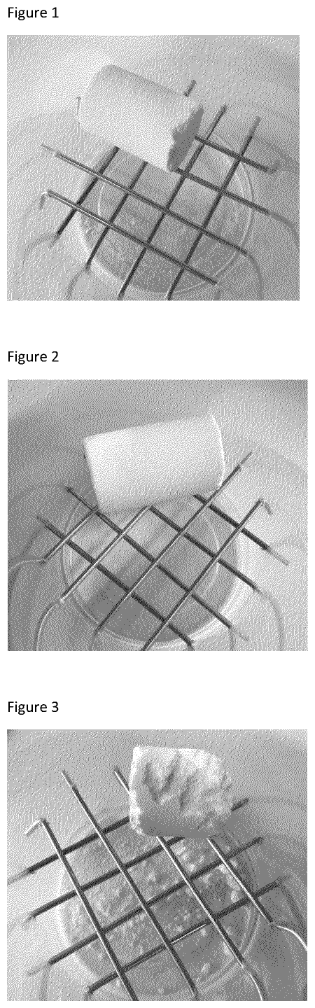

The result of the test is shown in FIG. 1. The sample is completely compacted and has no flowability under the criteria noted above.

### Comparative Example 2

In this Example 4 phr of D-Mannitol was added to the sample before drying. D-Mannitol was supplied by Sigma-Aldrich, and is a known anti-caking agent used in the food industry.

The result of the test is shown in FIG. 2. The sample is completely compacted and is considered to have no flowability under the criteria noted above.

### Comparative Example 3

In this Example 4 phr of a hydrotalcite (“hydrotalcite 1”) was added to the sample before drying. Hydrotalcite 1 is a commercially available hydrotalcite with a Mg content of 22.8 wt %.

The result of the test is shown in FIG. 3. The sample is largely still compacted and is considered to have no flowability under the criteria noted above.

### Comparative Example 4

In this Example 4 phr of a different hydrotalcite (“hydrotalcite 2”) was added to the sample before drying. Hydrotalcite 2 is a commercially available hydrotalcite with a Mg content of 20.8 wt %.

The results of the test are shown in FIGS. 4A and 4B, where FIG. 4A shows the sample before any vibrations are applied, and FIG. 4B shows the sample after the more vigorous vibration procedure. The sample is considered to have “poor” flowability under the criteria noted above.

### Comparative Example 5

In this Example 4 phr of a different hydrotalcite (“hydrotalcite 3”) was added to the sample before drying. Hydrotalcite 3 is a commercially available hydrotalcite with a Mg content of 22.3 wt %.

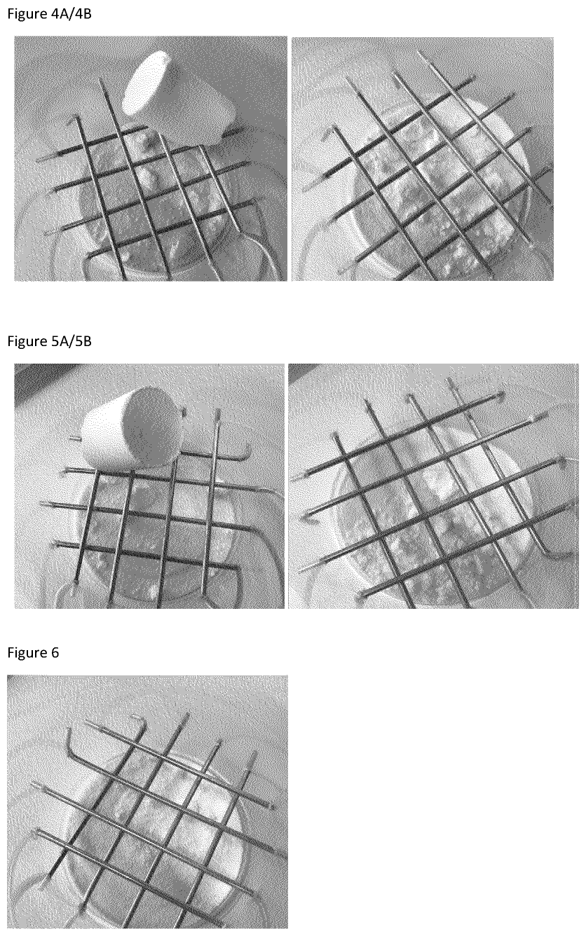

The results of the test are shown in FIGS. 5A and 5B, where FIG. 5A shows the sample before any vibrations are applied, and FIG. 5B shows the sample after the more vigorous vibration procedure. The sample is considered to have “poor” flowability under the criteria noted above.

### Example 1

In this Example 4 phr of a different hydrotalcite (“hydrotalcite 4”) was added to the sample before drying. Hydrotalcite 4 is a commercial hydrotalcite with a Mg content of 20.0 wt %.

The result of the test is shown in FIG. 6 which shows the sample before any vibrations are applied, and shows that the sample has passed completely through the grid. The sample is considered to have excellent flowability under the criteria noted above.

### Example 2

In this Example 4 phr of a different hydrotalcite (“hydrotalcite 5”) was added to the sample before drying. Hydrotalcite 5 is a commercially available hydrotalcite with a Mg content of 15.1 wt %.

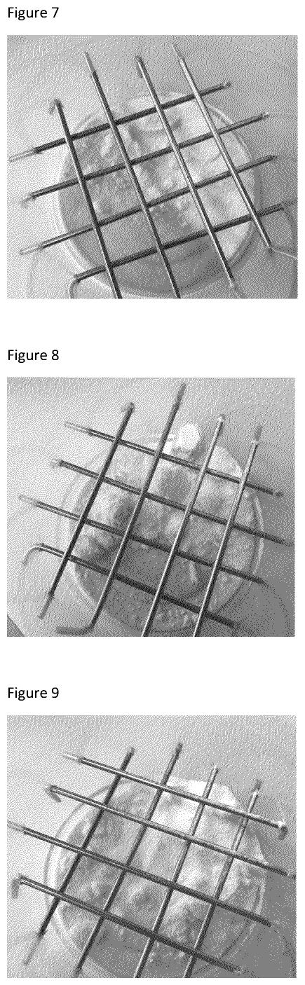

The result of the test is shown in FIG. 7 which shows the before any vibrations are applied, and shows that the sample has passed completely through the grid. The sample is considered to have excellent flowability under the criteria noted above.

### Example 3

In this Example 4 phr of a different hydrotalcite (“hydrotalcite 6”) was added to the sample before drying. Hydrotalcite 6 is a commercially available hydrotalcite with a Mg content of 19.9 wt %.

The result of the test is shown in FIG. 8 which shows the sample before any vibrations are applied, and shows that the sample has passed completely through the grid. The sample is considered to have excellent flowability under the criteria noted above.

### Example 4

In this Example 4 phr of a different hydrotalcite (“hydrotalcite 7”) was added to the sample before drying. Hydrotalcite 7 is a commercially available hydrotalcite with a Mg content of 14.3 wt %.

The result of the test is shown in FIG. 9 which shows the sample before any vibrations are applied, and shows that the sample has passed completely through the grid. The sample is considered to have excellent flowability under the criteria noted above.

The results, along with details of several other properties of the additives are summarised in Table 2:

TABLE 2

| | | Mg | | Zn | |
|---|---|---|---|---|---|
| | | content | Mg/Al | content | Flowability |
| Example | Additive | (wt %) | ratio | (wt %) | result |
| CE1 | (None) | N/A | N/A | N/A | None |
| CE2 | D-Mannitol | N/A | N/A | N/A | None |
| CE3 | Hydrotalcite 1 | 22.8 | 2.98 | n.d. | None |
| CE4 | Hydrotalcite 2 | 20.8 | 1.98 | <0.01 | Poor |
| CE5 | Hydrotalcite 3 | 22.3 | 2.03 | n.d. | Poor |
| 1 | Hydrotalcite 4 | 20.0 | 2.00 | n.d. | Excellent |
| 2 | Hydrotalcite 5 | 15.1 | 1.64 | 12.2 | Excellent |
| 3 | Hydrotalcite 6 | 19.9 | 2.17 | n.d. | Excellent |
| 4 | Hydrotalcite 7 | 14.3 | 1.62 | 11.0 | Excellent |

Comparative Example 1 shows that the PVC copolymer is strongly compacted after compression.

D-Mannitol is a conventional additive but does not provide a flowing product after the compaction test.

Hydrotalcites 1, 2 and 3 are hydrotalcite materials which each have more than 20.5 wt % magnesium, and the flowability of the resulting materials is “poor” at best.

Examples 1 to 4 show that, in contrast, hydrotalcite materials with less than 20.5 wt % magnesium in each case provide excellent flowability to the product even after the compaction test.

1. A composition comprising:
a. A polyvinylchloride containing copolymer which comprises vinyl chloride and a second monomer, and wherein the second monomer is a monomer whose homopolymer has a glass transition temperature, Tg, of less than 82° C., and
b. Up to 10 wt % of a hydrotalcite compound,
wherein the second monomer is selected from the group consisting of vinyl acetate and alkyl(meth)acrylates; and
wherein the hydrotalcite compound has 20.5 wt % or less of magnesium.

2. (canceled)

3. The composition according to claim 1 wherein the second monomer is an alkyl(meth)acrylate.

4. A composition comprising:
a. A polyvinylchloride containing copolymer which comprises vinyl chloride and an alkyl(meth)acrylate, and
b. Up to 10 wt % of a hydrotalcite compound,
wherein the hydrotalcite compound has 20.5 wt % or less of magnesium.

5. The composition according to claim 3 wherein the alkyl(meth)acrylate comprises a C2 to C8 alkyl group.

6. The composition according to claim 5 wherein the alkyl(meth)acrylate is ethylhexyl acrylate or n-butyl acrylate.

7. The composition according to claim 1 wherein the polyvinylchloride containing copolymer is a polyvinylchloride-butyl acrylate copolymer.

8. The composition according to claim 1 wherein the copolymer comprises at least 60 wt % vinyl chloride.

9. The composition according to claim 1 wherein the hydrotalcite compound has 20 wt % or less of magnesium.

10. The composition according to claim 1 wherein the hydrotalcite compound comprises at least 0.2 wt % of at least one metal selected from Sn, Pb, Ca, Ba, Zn and Cd.

11. The composition according to claim 10 wherein the at least one metal is Zn or Ca.

12. The composition according to claim 1 wherein the hydrotalcite compound comprises at least 10 wt % of zinc.

13. The composition according to claim 1 wherein the hydrotalcite compound has a Mg/Al molar ratio of 2.2 or less.

14. A method of using a hydrotalcite to reduce caking of a composition comprising:
providing the composition which comprises a polyvinylchloride containing copolymer, which copolymer comprises vinyl chloride and a second monomer, and wherein the second monomer is a monomer whose homopolymer has a glass transition temperature, Tg, of less than 82° C., wherein the second monomer is selected from vinyl acetate and alkyl(meth)acrylates; and
including a hydrotalcite compound in the composition, wherein the hydrotalcite compound has 20.5 wt % or less of magnesium.

15. (canceled)

16. The composition according to claim 1 wherein the second monomer is vinyl acetate.

17. The method according to claim 14 wherein the second monomer is an akyl(meth)acrylate.

18. The method according to claim 17 wherein the alkyl(meth)acrylate comprises a C2 to C8 alkyl group.

19. The method according to claim 17 wherein the alkyl(meth)acrylate is ethylhexyl acrylate or n-butyl acrylate.

20. The method according to claim 14 wherein the hydrotalcite compound comprises at least 0.2 wt % of at least one metal selected from Sn, Pb, Ca, Ba, Zn and Cd.

21. The method according to claim 20 wherein the at least one metal is Zn or Ca.

22. The method according to claim 14 wherein the hydrotalcite compound has a Mg/Al molar ratio of 2.2 or less.
